(19) United States
(12) Patent Application Publication
(10) Pub. No.: US 2017/0323108 A1
(43) Pub. Date: Nov. 9, 2017

(54) METHODS, DEVICES AND SYSTEMS FOR CONTROLLING ACCESS TO DATA

(71) Applicant: The Open University, Buckinghamshire (GB)

(72) Inventors: Vikram Mehta, Buckinghamshire (GB); Arosha Bandara, Buckinghamshire (GB); Blaine Price, Buckinghamshire (GB); Bashar Nuseibeh, Buckinghamshire (GB)

(21) Appl. No.: 15/587,942

(22) Filed: May 5, 2017

(30) Foreign Application Priority Data
May 6, 2016 (GB) 1607977.4

(51) Int. Cl. G06F 21/62; G06F 21/57; G08B 6/00; G06F 21/60

(52) U.S. Cl. CPC G06F 21/62; G08B 6/00; G06F 21/57; G06F 21/60

(57) ABSTRACT

The present invention provides a method of notifying a user of a request for data controlled by a server, the method including the steps of: monitoring, at the server, requests for data controlled by the server; and if a data request is detected which corresponds to a predetermined type of data request, notifying the user of the detected data request via a haptic feedback mechanism provided on a wearable device which is communicably coupled with the server. Embodiments of the invention relate to a wearable device and a system including the server and the wearable device. Embodiments of the invention allow users to be informed non-obtrusively of a potential privacy breach in real-time and may also allow a user to control in a non-intrusive (e.g. eyes-free) manner whether access is given to personal data.

### FIELD OF INVENTION

The present invention relates to methods, devices and systems for controlling access to data. The invention is particularly, but not exclusively, concerned with the notification to a user of potential access to data in an eyes-free manner and subsequent control of the access to the data in an eyes-free manner.

### BACKGROUND TO THE INVENTION

A lot of private and often sensitive information about users that is collected through ubiquitous devices can be shared with unknown entities at any time, without the users being aware. In order to control which of their personal data is being collected, who can collect such data, and when this is allowed, users currently need to go through and pre-set privacy rules for devices/applications they want to use [Choe et. al '13, Kelly et. al '09, '13]. Even then, controlling the diffusion of such information has become an increasingly daunting task, especially due to the innumerable possibilities of information flow and varying privacy preferences of users across different contexts. Moreover, setting privacy rules is a complex and time-consuming process which many people are unwilling to do until their privacy is violated [Felt et. al '12], thus increasing the risk of personal information privacy breaches. When such breaches (highly privacy sensitive or ambiguous, in particular) occur, appropriate interfaces are required to sensitively and actively warn users in real time, enable them to take immediate action when informed, and learn from their responses.

Research shows that privacy of personal data is a big concern for the users in all worldwide markets.

It is an object of the present invention to provide methods, devices and systems which can non-intrusively inform users of a potential privacy breach in real-time. It is a further object of the present invention to provide methods, devices and systems which allow a user to control in a non-intrusive (e.g. eyes-free) manner whether access is given to personal data.

It is a further object of the present invention to allow a user to intuitively understand the type, severity and/or nature of the request for data.

### STATEMENTS OF INVENTION

At their broadest, aspects of the present invention provide methods, devices and systems which allow a user to be notified of a request made for data by a haptic feedback mechanism on a wearable device and, optionally, to control access to the data by haptic interaction with the wearable device.

A first aspect of the invention provides a method of notifying a user of a request made for data controlled by a server, the method including the steps of: monitoring, at the server, requests for data controlled by the server; and if a data request is detected which corresponds to a predetermined type of data request, notifying the user of the detected data request via a haptic feedback mechanism provided on a wearable device which is communicably coupled with the server.

The method of this aspect can provide a direct, intuitive, inherently private (non-intrusive) method of communicating information about requests for data to a user.

In particular the predetermined types of data request may be requests for private or personal data. This may include, without limitation, one or more of: location data, financial data, identification data, health and wellbeing data, lifestyle data, family and relationships data, personal communications, data on historical use of applications, systems or websites.

Preferably the method further includes the steps of: detecting a haptic interaction by the user with the wearable device in response to the notification; communicating the interaction to the server; and based on the interaction, permitting or denying the request for data.

By providing for haptic interaction by the user with the device, the user can be notified of a potential access to data (privacy breach) and control whether access is permitted or denied in response to that notification in a non-intrusive, eyes-free manner.

Based on the interaction, the server may determine a privacy setting which determines how the server responds to future data requests of the same type of data request type. In this manner the server can “learn” the preferences of a user for access to certain types or kinds of data.

In some embodiments, the wearable device includes first and second touch-sensitive inputs, wherein interaction by the user with the first touch-sensitive input causes the server to deny the request for data and interaction by the user with the second touch-sensitive input causes the server to allow the request for data. Thus one input is used for each option allowing the user to permit or deny access to the data.

Indeed, there may be more than two touch-sensitive inputs, either permitting further levels of interaction by the user with the wearable device, or providing duplication of the inputs.

Alternatively or additionally, the touch sensitive input(s) may be configured to respond to different degrees of interaction and allow the user to convey different inputs depending on the degree of interaction. For example, a hard touch, press or squeeze on a particular input may be interpreted as a instruction to permanently deny access to the data, whilst a light touch, press or squeeze may be interpreted as a temporary block on access to the data.

In particular embodiments, the wearable device is arranged such that, when worn by the user, the first and second touch-sensitive inputs are arranged substantially opposite each other. For example, the first touch-sensitive input may be positioned on the inner (volar) side of the forearm and the second touch-sensitive input positioned on the outer (dorsal) side of the forearm. In another example, the first touch-sensitive input may be positioned adjacent to the wrist on the user's forearm and the second touch-sensitive input positioned adjacent to the elbow on the user's forearm. This allows for clear physical distinction between the inputs which are used for the two options.

Preferably the haptic feedback mechanism is activated with different levels of intensity depending on the type of the data request. For example, high intensity activation may be used to notify the user of a high risk data request, for example a request for financial information, whilst a low intensity activation may be used to notify the user of a low risk data request, such as a request for access to generalised location information.

The wearable device may be an armband and may have a plurality of haptic feedback mechanisms, wherein the haptic feedback mechanisms are arranged such that, when the wearable device is worn by the user, the haptic feedback mechanisms are positioned adjacent to different points on a volar part of the user's forearm. It is known that users are able to detect and distinguish haptic sensations on different parts of the volar forearm.

The forearm is also a good location for a discreet wearable device as it will often be under other clothing, and is a part of the body that is easy for the user to interact with (for example to make decisions regarding permitting or denying access to the data) without making unusual actions or drawing attention to their actions.

The provision of multiple haptic feedback mechanisms means that they can be activated in different patterns depending on the type of the data request. For example the sequence or combination of activation of the haptic feedback mechanisms may allow the user to distinguish between a request for financial information, a request for location information, a request for shopping history data, etc.

In particular embodiments, the method further includes the steps of: classifying the severity of the data request; and controlling the haptic feedback mechanism(s) to provide different feedback depending on the classification.

In certain embodiments the server and the wearable device communicate via a mobile device such as a mobile telephone, smartphone, tablet, smart watch, laptop computer. For example, the server may communicate with the mobile device over an Internet connection (WiFi, 3G, 4G, etc.). The mobile device may communicate with the wearable device over a more localised communication protocol such as Bluetooth.

By using a mobile device as an intermediary between the server and the wearable device, the wearable device does not require a complex, high power and/or costly communication facility to allow direct connection to the server. As most mobile devices are fitted with a Bluetooth communication capability and Bluetooth transceivers are relatively inexpensive, the wearable device can use the existing communication capabilities of the mobile device, whilst being in itself relatively simple.

The use of a mobile device also means that the control and processing for the haptic feedback and interactions can be performed on the mobile device, using the existing processing capability of the mobile device and further reducing the size, cost and power supply requirements of the wearable device itself.

In certain embodiments, the mobile device is the server and the data may also be stored on the mobile device (e.g. current location data).

Whether the server is the mobile device or separate (e.g. a bank's server, or a social media site's server), the data may be stored on the server itself, or may be stored remotely (e.g. in a data centre, or cloud storage).

The method of the present aspect may include any combination of some, all or none of the above described preferred and optional features.

Further aspects of the present invention include computer programs for running on computer systems which carry out the method of the above aspect, including some, all or none of the preferred and optional features of that aspect.

A second aspect of the present invention provides a wearable device for notifying a user wearing the device of a request made for data controlled by a server, the device having a haptic feedback mechanism and a controller, wherein the wearable device is configured to: receive communications from the server; and on receipt of a communication from the server indicating that a data request has been detected which corresponds to a predetermined type of data request, control said haptic feedback mechanism to notify the user of the detected data request via the haptic feedback mechanism.

The wearable device of this aspect can provide a direct, intuitive, inherently private (non-intrusive) method of communicating information about requests for data to a user wearing the device.

In particular the predetermined types of data request may be requests for private or personal data. This may include, without limitation, one or more of: location data, financial data, identification data, health and wellbeing data, lifestyle data, family and relationships data, personal communications, data on historical use of applications, systems or websites.

Preferably the device further includes a haptic input mechanism, wherein the controller is configured to: detect an interaction by the user with the haptic input mechanism in response to the notification; and communicate an instruction to permit or deny the request for data to the server based on said interaction.

By providing for haptic interaction by the user with the device, the user can be notified of a potential access to data (privacy breach) and control whether access is permitted or denied in response to the notification in a non-intrusive, eyes-free manner.

Based on the interaction, the server may determine a privacy setting which determines how the server responds to future data requests of the same type of data request type. In this manner the server can “learn” the preferences of a user for access to certain types or kinds of data.

In some embodiments, the wearable device further includes first and second touch-sensitive inputs, wherein detection of interaction by the user with the first touch-sensitive input causes the controller to send an instruction to the server to deny the request for data and detection of interaction by the user with the second touch-sensitive input causes the controller to send an instruction to the server to permit the request for data. Thus one input is used for each option allowing the user to permit or deny access to the data.

Indeed, there may be more than two touch-sensitive inputs, either permitting further levels of interaction by the user with the wearable device, or providing duplication of the inputs.

Alternatively or additionally, the touch sensitive input(s) may be configured to respond to different degrees of interaction and allow the user to convey different inputs depending on the degree of interaction. For example, a hard touch, press or squeeze on a particular input may be interpreted as a instruction to permanently deny access to the data, whilst a light touch, press or squeeze may be interpreted as a temporary block on access to the data.

In particular embodiments, the wearable device is configured such that, when the notification device is worn by the user, the first and second touch-sensitive inputs are arranged substantially opposite each other. For example, the first touch-sensitive input may be positioned on the inner (volar) side of the forearm and the second touch-sensitive input positioned on the outer (dorsal) side of the forearm. In another example, the first touch-sensitive input may be positioned adjacent to the wrist on the user's forearm and the second touch-sensitive input positioned adjacent to the elbow on the user's forearm. This allows for clear physical distinction between the inputs which are used for the two options.

The input or inputs may be configured as including a pressure-sensitive conductive layer which is sandwiched between two layers of conductive fabric. This allows for a low profile (i.e. thin) electrical switch to be formed which is capable of detecting a touch or stroke of the user.

Preferably the controller activates the haptic feedback mechanisms with different levels of intensity depending on the type of the data request. For example, high intensity activation may be used to notify the user of a high risk data request, for example a request for financial information, whilst a low intensity activation may be used to notify the user of a low risk data request, such as a request for access to generalised location information.

The wearable device may be an armband and may have a plurality of haptic feedback mechanisms, wherein the haptic feedback mechanisms are arranged such that, when the wearable device is worn by the user, the haptic feedback mechanisms are positioned adjacent to different points on a volar part of the user's forearm. It is known that users are able to detect and distinguish haptic sensations on different parts of the volar forearm.

The forearm is also a good location for a discreet wearable device as it will often be under other clothing, and is a part of the body that is easy for the user to interact with (for example to make decisions regarding permitting or denying access to the data) without making unusual actions or drawing attention to their actions.

The provision of multiple haptic feedback mechanisms means that they can be activated in different patterns depending on the type of the data request. For example the sequence or combination of activation of the haptic feedback mechanisms may allow the user to distinguish between a request for financial information, a request for location information, a request for shopping history data, etc.

In particular embodiments, the controller is configured to receive a classification of the data request from the server and to activate the haptic feedback mechanisms to provide different feedback depending on the classification.

In certain embodiments the server and the wearable device communicate via a mobile device such as a mobile telephone, smartphone, tablet, smart watch, laptop computer. For example, the server may communicate with the mobile device over an Internet connection (WiFi, 3G, 4G, etc.). The mobile device may communicate with the wearable device over a more localised communication protocol such as Bluetooth.

By using a mobile device as an intermediary between the server and the wearable device, the wearable device does not require a complex, high power and/or costly communication facility to allow direct connection to the server. As most mobile devices are fitted with a Bluetooth communication capability and Bluetooth transceivers are relatively inexpensive, the wearable device can use the existing communication capabilities of the mobile device, whilst being in itself relatively simple.

The use of a mobile device also means that the control and processing for the haptic feedback and interactions can be performed on the mobile device, using the existing processing capability of the mobile device and further reducing the size, cost and power supply requirements of the wearable device itself.

In certain embodiments, the mobile device is the server and the data may also be stored on the mobile device (e.g. current location data).

Whether the server is the mobile device or separate (e.g. a bank's server, or a social media site's server), the data may be stored on the server itself, or may be stored remotely (e.g. in a data centre, or cloud storage).

The wearable device of the present aspect may include any combination of some, all or none of the above described preferred and optional features.

The wearable device of the present aspect preferably operates by performing a method according to the above-described first aspect, including some, all or none of the optional or preferred features of that aspect.

A third aspect of the present invention provides a system for notifying a user of a request for data controlled by a server, the system including: a memory device having data stored thereon; a server controlling access to the data; and a wearable device communicatively coupled to the server and having a controller and haptic feedback mechanism, wherein the server is configured to monitor requests for data controlled by the server and, if a data request is detected which corresponds to a predetermined type of data request, communicate with the wearable device to control the haptic feedback mechanism to notify the user of the detected data request.

The system of this aspect can provide a direct, intuitive, inherently private (non-intrusive) method of communicating information about requests for data to a user.

In particular the predetermined types of data request may be requests for private or personal data. This may include, without limitation, one or more of: location data, financial data, identification data, health and wellbeing data, lifestyle data, family and relationships data, personal communications, data on historical use of applications, systems or websites.

Preferably the wearable device further includes a haptic input mechanism and wherein the controller is configured to: detect an interaction by the user with the haptic input mechanism in response to the notification; and communicate an instruction to permit or deny the request for data to the server based on said interaction, and wherein the server is configured to permit or deny the request for data based on the instruction from the wearable device.

By providing for haptic interaction by the user with the device, the user can be notified of a potential access to data (privacy breach) and control whether access is permitted or denied in response to that notification in a non-intrusive, eyes-free manner.

Based on the interaction, the server may determine a privacy setting which determines how the server responds to future data requests of the same type of data request type. In this manner the server can “learn” the preferences of a user for access to certain types or kinds of data.

In some embodiments, the wearable device includes first and second touch-sensitive inputs, wherein interaction by the user with the first touch-sensitive input causes the server to deny the request for data and interaction by the user with the second touch-sensitive input causes the server to allow the request for data. Thus one input is used for each option allowing the user to permit or deny access to the data.

Indeed, there may be more than two touch-sensitive inputs, either permitting further levels of interaction by the user with the wearable device, or providing duplication of the inputs.

Alternatively or additionally, the touch sensitive input(s) may be configured to respond to different degrees of interaction and allow the user to convey different inputs depending on the degree of interaction. For example, a hard touch, press or squeeze on a particular input may be interpreted as a instruction to permanently deny access to the data, whilst a light touch, press or squeeze may be interpreted as a temporary block on access to the data.

In particular embodiments, the wearable device is configured such that, when worn by the user, the first and second touch-sensitive inputs are arranged substantially opposite each other. For example, the first touch-sensitive input may be positioned on the inner (volar) side of the forearm and the second touch-sensitive input positioned on the outer (dorsal) side of the forearm. In another example, the first touch-sensitive input may be positioned adjacent to the wrist on the user's forearm and the second touch-sensitive input positioned adjacent to the elbow on the user's forearm. This allows for clear physical distinction between the inputs which are used for the two options.

The input or inputs may be configured as including a pressure-sensitive conductive layer which is sandwiched between two layers of conductive fabric. This allows for a low profile (i.e. thin) electrical switch to be formed which is capable of detecting a touch or stroke of the user.

Preferably the haptic feedback mechanism is activated with different levels of intensity depending on the type of the data request. For example, high intensity activation may be used to notify the user of a high risk data request, for example a request for financial information, whilst a low intensity activation may be used to notify the user of a low risk data request, such as a request for access to generalised location information.

The wearable device may be an armband and may have a plurality of haptic feedback mechanisms, wherein the haptic feedback mechanisms are arranged such that, when the wearable device is worn by the user, the haptic feedback mechanisms are positioned adjacent to different points on a volar part of the user's forearm. It is known that users are able to detect and distinguish haptic sensations on different parts of the volar forearm.

The forearm is also a good location for a discreet wearable device as it will often be under other clothing, and is a part of the body that is easy for the user to interact with (for example to make decisions regarding permitting or denying access to the data) without making unusual actions or drawing attention to their actions.

The provision of multiple haptic feedback mechanisms means that they can be activated in different patterns depending on the type of the data request. For example the sequence or combination of activation of the haptic feedback mechanisms may allow the user to distinguish between a request for financial information, a request for location information, a request for shopping history data, etc.

In particular embodiments the server is configured to classify the severity of the data request and to transmit the classification to the wearable device; and the controller is configured to activate the haptic feedback mechanisms in different patterns depending on the classification.

In certain embodiments the system further includes a mobile device, such as a mobile telephone, smartphone, tablet, smart watch, laptop computer, and the server and the wearable device communicate via the mobile device. For example, the server may communicate with the mobile device over an Internet connection (WiFi, 3G, 4G, etc.). The mobile device may communicate with the wearable device over a more localised communication protocol such as Bluetooth.

By using a mobile device as an intermediary between the server and the wearable device, the wearable device does not require a complex, high power and/or costly communication facility to allow direct connection to the server. As most mobile devices are fitted with a Bluetooth communication capability and Bluetooth transceivers are relatively inexpensive, the wearable device can use the existing communication capabilities of the mobile device, whilst being in itself relatively simple.

The use of a mobile device also means that the control and processing for the haptic feedback and interactions can be performed on the mobile device, using the existing processing capability of the mobile device and further reducing the size, cost and power supply requirements of the wearable device itself.

In certain embodiments, the mobile device is the server and the data may also be stored on the mobile device (e.g. current location data).

Whether the server is the mobile device or separate (e.g. a bank's server, or a social media site's server), the data may be stored on the server itself, or may be stored remotely (e.g. in a data centre, or cloud storage).

The system of the present aspect may include any combination of some, all or none of the above described preferred and optional features.

The system of the present aspect preferably operates by performing a method according to the above-described first aspect, including some, all or none of the optional or preferred features of that aspect.

These and other aspects of the invention are described in further detail below.

### BRIEF DESCRIPTION OF THE FIGURES

FIGS. 1A and 1B show a wearable device according to an embodiment of the present invention on the arm of a user from opposite sides;

FIG. 2 is a circuit diagram of the electronic components of a wearable device according to an embodiment of the present invention; and

FIG. 3 is a schematic flow chart showing the components of a system according to an embodiment of the present invention and the data flows between them.

### DETAILED DESCRIPTION

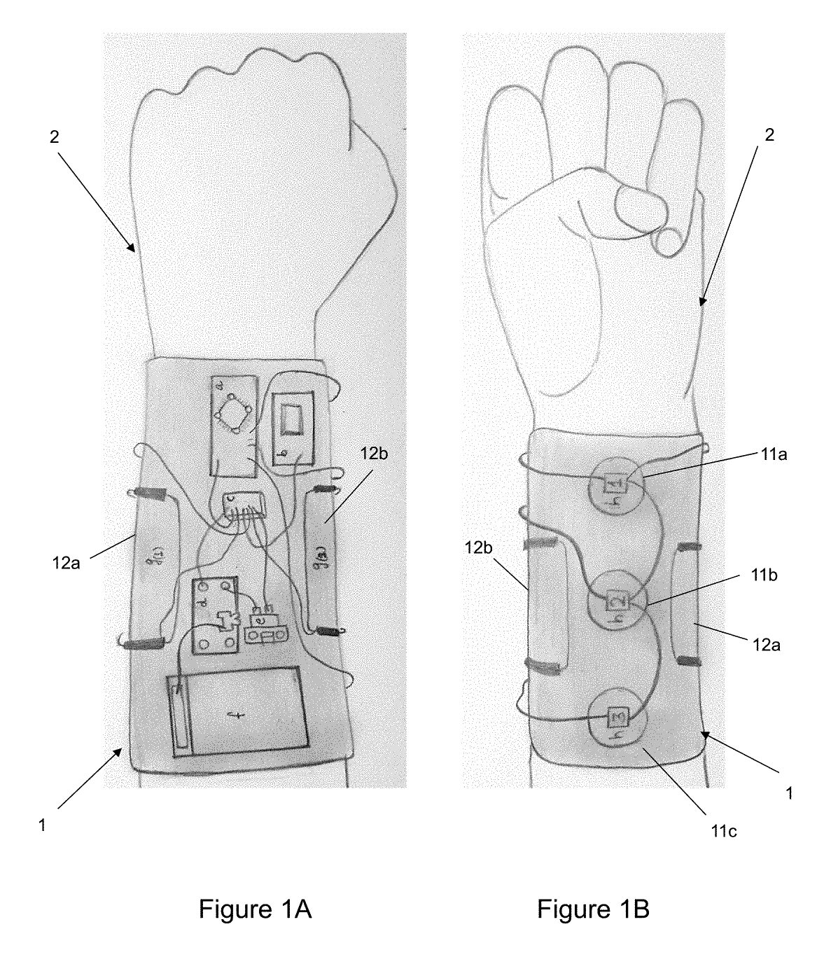

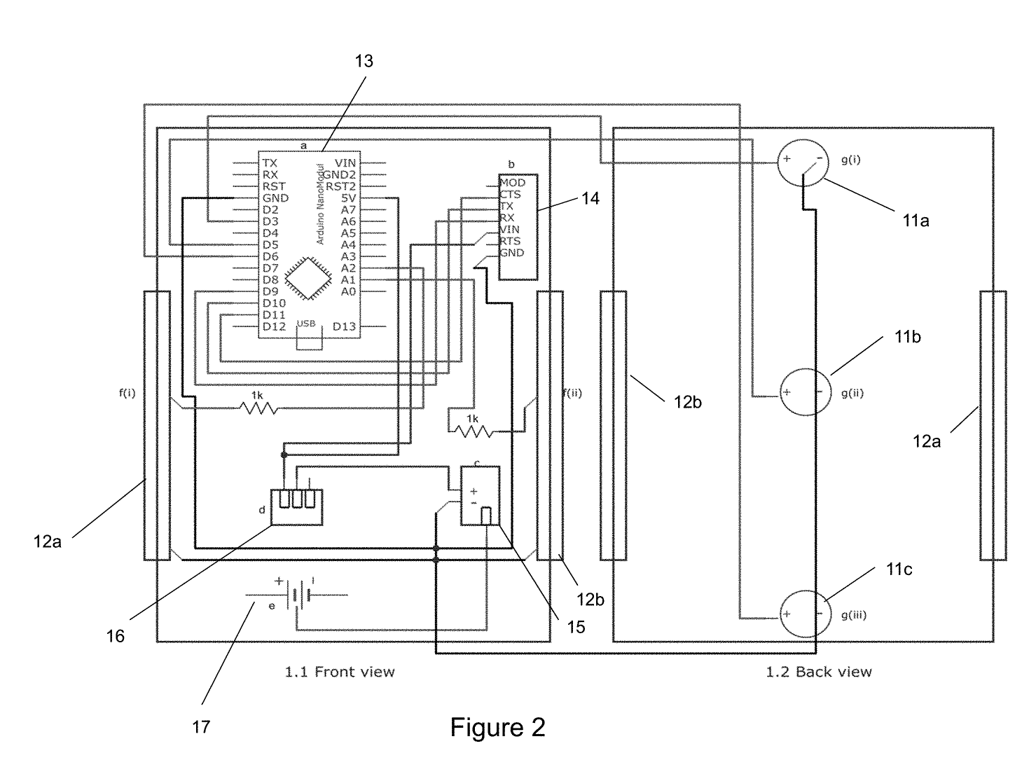

FIGS. 1A and 1B illustrate, respectively, the dorsal (outer) and volar (inner) views of a wearable device 1 according to an embodiment of the present invention in position on a user's arm 2. The layout of the electronic components in FIG. 1 and their connections are illustrative and not intended to be comprehensive. The connections of the components will be described in more detail below in relation to FIG. 2.

The wearable device 1 is a thin interactive band worn on the forearm. The base structure is a thin, flexible and elastic fabric band 10 of dimensions 15 cm×8 cm, which can be made from a cotton/elastane/polyamide blend. The band may be stretchable to be pulled over the user's hand, or may have a longitudinal join, such as a hook-and-loop tape. On the inner side of the band, three vibration motors 11a-11c (e.g. LilyPad Vibe Boards which generate a vibration amplitude of 0.8G from a 5V supply) are placed at 7.5 cm intervals. This arrangement divides the user's forearm into 3 distinct input points.

The outer (away from the user) and inner (towards the user) sides are both sewn with pressure sensitive fabric buttons 12a, 12b. These buttons are integrated into the fabric of the band 10 and, in the embodiment illustrated, are constructed as a layer of pressure-sensitive conductive sheet (e.g. Velostat/Linqstat) which is sandwiched between two pieces of conductive fabric (e.g. silver-plated nylon such as Medtex), so that the conductive fabric faces inwards, towards each other, separated only by the Velostat. The band 10 may form an inner and outer layer to the conductive and pressure-sensitive fabric layers, or these layers may be sewn or otherwise fastened to the band 10.

Although the present embodiment is a fabric band which is worn on the user like clothing, other embodiments are possible in which the wearable device is a layer applied to the user's body like artificial skin or a tattoo. In particular, skin worn sensors such as iSkin [4] could be used to create aesthetic and more fitting designs of the wearable device as the technology develops.

FIG. 2 is the circuit diagram of the control circuitry of a wearable device according to an embodiment of the present invention. A micro-controller (e.g., an Arduino Nano v3.0) 13 is connected to a low energy Bluetooth module (e.g. an Adafruit Bluefruit LE UART Friend—Bluetooth Low Energy (BLE)) 14; a PowerBoost 500C chip 15; an on-off switch 16; and a 3.7V Li-Ion polymer battery 17.

The vibration motors 11 are connected to the analog outputs of the microcontroller 13 to create variations in vibration intensity: “High” is at analog output value of 255, “Low” at analog output value of 125. As discussed further below, in embodiments of the present invention, differences in vibration intensity can be used to convey different messages or different levels of warning. For example, a high vibration intensity can be used to convey a critical warning, whilst a low vibration intensity can be used to convey a mild warning.

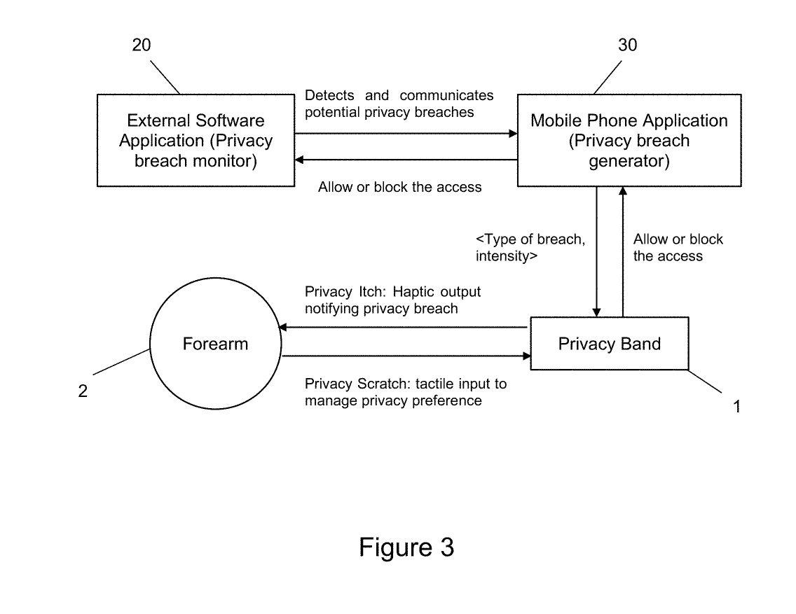

FIG. 3 illustrates the data and control flow in a system according to an embodiment of the present invention. Software components on a server 20 monitor the user's personal information flows and detect potential privacy breaches. These components communicate with a specialised software application running on the user's smartphone (or other mobile communications device such as a tablet or smart watch) 30 that connects to the wearable device 1 via Bluetooth.

The server 20 communicates a detected potential privacy breach to the smartphone application. This checks the potential breach against a stored list of breaches or otherwise classifies the breach

Depending upon the classification and the type of potential privacy breach, the app instructs the band when and how to vibrate. The corresponding vibration motors 11 then vibrate accordingly creating a metaphoric “privacy itch” (until the user responds) and the user is haptically warned on his forearm in an “eyes-free” manner.

Various models or tools such as Dynamic Bayesian Networks [11] or PROTOSS [12] are known that can detect an on-going, or predict a future, personal information privacy breach. Similarly, Yang et al. [13] provide a model to calculate the potential privacy risk of users' online information. Such applications (which may be accessed externally to the server or smartphone, or embedded within the software running on either) can be used to detect the type and intensity of the privacy breach of user data.

In some embodiments, the user may be able to set a parameter which governs the feedback that they receive from the band. For example, the user could set this parameter to “do not disturb” (in which case no warnings are forwarded to the wearable device), “busy” (only “high risk” warnings forwarded) or “normal” (all warnings forwarded).

To respond to the warnings, the user can simply scratch on the sides of the band without any need to look at it. In the embodiment illustrated, a scratch on the button 12a on the outer side enables the user to ignore or dismiss the privacy warning (thus allowing access to the data), and one on the button on the inner side 12b enables the user to block the access to the corresponding data item. Note that, in this context, the word “scratch” is used to denote any sort of touch input to an area of the band such as scratching, pressing, sliding with pressure, squeezing, shearing or twisting by the user.

Note that, in the arrangement shown in FIG. 3, the server 20 and smartphone 30 are separate entities. However, their functions could be combined. For example, the server 20 may communicate directly with the wearable device 1 using mobile telecommunications protocols, or other wireless communication protocols (e.g. WiFi). In other examples, the data to which access is being requested is stored on the smartphone 30 (or other mobile device) and so the smartphone 30 itself detects the potential privacy breach and passes it to the application for communication to the wearable device.

In other embodiments, the checking and classification of the potential breach can be performed by the software on the server 20 and the classification and categorisation can be communicated to the software on the smartphone 30 which serves simply to interface with the wearable band 1.

A number of examples of the use of the system according to embodiments of the present invention will now be described.

In a first example, a first person (“Adam”) is in a café with a second person (“Bob”). A third person activates a “buddy tracker” application to try to locate Adam. The “buddy tracker” application on Charlie's device sends a request to Adam's smartphone seeking information on Adam's location from Adam's smartphone. Adam's smartphone detects the request and triggers an alert to the wearable device 1 on Adam's arm, causing it to vibrate in a pattern which is associated with a request for location information. This informs and warns Adam of the request received by his smartphone. Adam can respond to the information request by scratching his forearm to either deny access to the data (which, in this example, may have the effect of providing only an approximate location, or providing no location data at all), or to permit access to the data, in which case his smartphone will communicate its location data to the “buddy tracker” application on Charlie's device.

In a second example, the device (smartphone/tablet) belongs to a first person (“Adam”) who lends it to a second person (e.g. a child, “Bob”), for example to allow Bob to play games on the device. To save time, Adam hands over the phone without changing his phone settings or blocking access to any age restricted or sensitive applications. The device is however, connected with the wearable band which Adam wears. Bob, while playing a game, accidentally clicks on an advertisement to buy something online. Since Adam's stores his credit card details on his device, completion of the transaction is potentially just two clicks away. Adam is notified by an intense itch on his forearm as soon as the shopping cart accesses his card details. He then chooses to block the access, avoiding any accidental/intentional transactions that Bob might make from his device. This setting may be permanent until reset on the device itself.

In a development of the second example, the software which stores and retrieves the card details may be set to require a positive response from the user (by interaction with the wearable band) before transferring the card details to the shopping cart. This can provide an additional layer of security for certain information stored on the device and potentially used by applications running on the device.

In a third example, a user (“Adam”) regularly uses the gym and jogs in his local area but starts to experience some muscle pain. He calls his doctor to discuss this, who accesses his exercise records to evaluate if he is overdoing things. Adam receives a notification as a low-intensity vibration, which he chooses to allow by scratching the outer side of his forearm. While looking at the exercise records, the doctor also attempts to view the routes of Adam's runs which triggers a high-intensity notification in relation to Adam's location data. Adam is able to block the doctor's access to this data by scratching the inner side of his forearm.

In a fourth example, a user (“Alice”) uses messenger services on her mobile phone. She chats with another person (“Bob”) quite frequently and also shares her pictures, which she views as personal and would not like to share with anybody else. Bob however, has bad intentions and he attempts to forward his chats with Alice and her pictures to his friends without her consent. Alice receives notification on her wearable band as a high intensity vibration. She scratches the inner side of her forearm and chooses to block the further distribution of or wider access to her data.

As it has multiple vibration motors 11, the wearable band 1 is able to adapt the location, intensity and pattern of the ‘itch’ based on the type and severity of the breach. This mapping could be based on rules that use these factors (together with additional context information) to decide, which are either user defined in advance (or by periodic updates) or learned based on the scratch feedback (e.g., If a user repeatedly allows information flows that the system tags as potentially high severity breaches, the system adapts the rules to lower the intensity of the itch).

The systems and methods of the above embodiments may be implemented in a computer system (in particular in computer hardware or in computer software) in addition to the structural components and user interactions described.

The term “computer system” includes the hardware, software and data storage devices for embodying a system or carrying out a method according to the above described embodiments. For example, a computer system may comprise a central processing unit (CPU), input means, output means and data storage. Preferably the computer system has a monitor to provide a visual output display (for example in the design of the business process). The data storage may comprise RAM, disk drives or other computer readable media. The computer system may include a plurality of computing devices connected by a network and able to communicate with each other over that network.

Any of the computing devices (e.g. the server) used in embodiments of this invention may be mobile devices. Indeed, embodiments of the invention can be implemented in all kinds of computing architecture, including, without limitation: a fully mobile/portable arrangement; and a cloud-based arrangement where all of the data and software are based in the cloud and the software that implements a method according to an embodiment of the present invention is provided as a service.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

### REFERENCES

1. An, X., Jutla, D., and Cercone, N. Privacy intrusion detection using dynamic Bayesian networks. ACM Int. Conf. Proc. Series, (2006), 208-215.
2. Kafali, O., Gunay, A., and Yolum, P. PROTOSS: A Run Time Tool for Detecting Privacy Violations in Online Social Networks. Int. Conf. on Advances in social networks analysis and mining, IEEE (2012), 429-433.
3. Yang, M., Yu, Y., Bandara, A. K., and Nuseibeh, B. Adaptive sharing for online social networks: a trade-off between privacy risk and social benefit. Proc. of the 13th Int. Conf. on Trust, Security and Privacy in Computing and Communications, IEEE (2014), 45-52.
4. Weigel, M., Lu, T., Bailly, G., Oulasvirta, A., Majidi, C., and Steimle, J. iSkin: flexible, stretchable and visually customizable on-body touch sensors for mobile computing. Proc. of the 33rd Conf. on Human Factors in Computing Systems, ACM (2015), 2991-3000.

All of the above references are hereby incorporated by reference.

1. A method of notifying a user of a request for data controlled by a server, the method including the steps of:
monitoring, at the server, requests for data controlled by the server; and
if a data request is detected which corresponds to a predetermined type of data request, notifying the user of the detected data request via a haptic feedback mechanism provided on a wearable device which is communicably coupled with the server.

2. A method according to claim 1, further including the steps of:
detecting a haptic interaction by the user with the wearable device in response to the notification;
communicating the interaction to the server; and
based on the interaction, permitting or denying the request for data.

3. A method according to claim 2, wherein, based on the interaction, the server determines a privacy setting which determines how the server responds to future data requests of the same type of data request type.

4. A method according to claim 2, wherein the wearable device includes first and second touch-sensitive inputs,
wherein interaction by the user with the first touch-sensitive input causes the server to deny the request for data and interaction by the user with the second touch-sensitive input causes the server to allow the request for data.

5. A method according to claim 4 wherein, when the wearable device is worn by the user, the first and second touch-sensitive inputs are arranged substantially opposite each other.

6. A method according to claim 1, wherein the haptic feedback mechanism is activated with different levels of intensity depending on the type of the data request.

7. A method according to claim 1, wherein the wearable device is an armband and has a plurality of haptic feedback mechanisms,
wherein the haptic feedback mechanisms are arranged such that, when the wearable device is worn by the user, the haptic feedback mechanisms are positioned adjacent to different points on a volar part of the user's forearm.

8. A method according to claim 7 wherein the haptic feedback mechanisms are activated in different patterns depending on the type of the data request.

9. A method according to claim 1, further including the steps of:
classifying the severity of the data request; and
controlling the haptic feedback mechanism to provide different feedback depending on the classification.

10. A method according to claim 1, wherein the wearable device and server communicate via a mobile device.

11. A wearable device for notifying a user wearing the device of a request made for data controlled by a server, the device having a haptic feedback mechanism and a controller, wherein the wearable device is configured to:
receive communications from the server; and
on receipt of a communication from the server indicating that a data request has been detected which corresponds to a predetermined type of data request, control said haptic feedback mechanism to notify the user of the detected data request via the haptic feedback mechanism.

12. A wearable device according to claim 11, wherein the device further includes a haptic input mechanism, wherein the controller is configured to:
detect an interaction by the user with the haptic input mechanism in response to the notification; and
communicate an instruction to permit or deny the request for data to the server based on said interaction.

13. A wearable device according to claim 11, wherein the wearable device further includes first and second touch-sensitive inputs,
wherein detection of an interaction by the user with the first touch-sensitive input causes the controller to send an instruction to the server to deny the request for data and detection of an interaction by the user with the second touch-sensitive input causes the controller to send an instruction to the server to permit the request for data.

14. A wearable device according to claim 13, wherein the wearable device is configured such that, when the notification device is worn by the user, the first and second touch-sensitive inputs are arranged substantially opposite each other.

15. A wearable device according to claim 11, wherein at least one of the touch-sensitive inputs includes a pressure-sensitive conductive layer which is sandwiched between two layers of conductive fabric.

16. A wearable device according to claim 11, wherein the controller activates the haptic feedback mechanisms with different levels of intensity depending on the type of the data request.

17. A wearable device according to claim 11, wherein the wearable device is an armband and has a plurality of haptic feedback mechanisms,
wherein the haptic feedback mechanisms are arranged such that, when the wearable device is worn by the user, the haptic feedback mechanisms are positioned adjacent to different points on a volar part of the user's forearm.

18. A wearable device according to claim 17 wherein the controller is configured to receive a classification of the data request from the server and to activate the haptic feedback mechanisms to provide different feedback depending on the classification.

19. A wearable device according to any one of claim 11, wherein the controller is configured to receive an indication from the server which indicates whether the data request has already been fulfilled and control the haptic feedback mechanism to notify this to the user.

20. A system for notifying a user of a request for data controlled by a server, the system including:
a memory device having data stored thereon;
a server controlling access to the data; and
a wearable device communicatively coupled to the server and having a controller and haptic feedback mechanism,
wherein the server is configured to monitor requests for data controlled by the server and, if a data request is detected which corresponds to a predetermined type of data request, communicate with the wearable device to control the haptic feedback mechanism to notify the user of the detected data request.

21. A system according to claim 20, wherein the wearable device further includes a haptic input mechanism and wherein the controller is configured to:
detect an interaction by the user with the haptic input mechanism in response to the notification; and
communicate an instruction to permit or deny the request for data to the server based on said interaction, and wherein
the server is configured to permit or deny the request for data based on the instruction from the wearable device.

22. A system according to claim 21, wherein, based on the interaction, the server determines a privacy setting which determines how the server responds to future data requests of the same type of data request type.

23. A system according to claim 21, wherein the wearable device includes first and second touch-sensitive inputs,
wherein interaction by the user with the first touch-sensitive input causes the server to deny the request for data and interaction by the user with the second touch-sensitive input causes the server to allow the request for data.

24. A system according to claim 23, wherein the wearable device is configured such that, when the notification device is worn by the user, the first and second touch-sensitive inputs are arranged substantially opposite each other.

25. A system according to claim 21, wherein at least one of the touch-sensitive inputs includes a pressure-sensitive conductive layer which is sandwiched between two layers of conductive fabric.

26. A system according to claim 25, wherein the haptic feedback mechanism is activated with different levels of intensity depending on the type of the data request.

27. A system according to claim 20, wherein the wearable device is an armband and has a plurality of haptic feedback mechanisms,
wherein the haptic feedback mechanisms are arranged such that, when the wearable device is worn by the user, the haptic feedback mechanisms are positioned adjacent to different points on a volar part of the user's forearm.

28. A system according to claim 27 wherein:
the server is configured to classify the severity of the data request and to transmit the classification to the wearable device; and
the controller is configured to activate the haptic feedback mechanisms in different patterns depending on the classification.

29. A system according to claim 20, further including a mobile device which is in communication with both the server and the wearable device and wherein communications from the server to the wearable device and vice-versa are made through the mobile device.

30. A system according to claim 20 wherein the server is a mobile device and the data is stored on the mobile device.
